(19) United States
(12) Patent Application Publication
(10) Pub. No.: US 2025/0379879 A1
(43) Pub. Date: Dec. 11, 2025

(54) CLOUD-BASED PROCESS MANAGEMENT SYSTEM AND METHOD

(71) Applicant: Pedro Fernando Ruiz Leon, Cypress, TX (US)

(72) Inventor: Pedro Fernando Ruiz Leon, Cypress, TX (US)

(21) Appl. No.: 19/230,406

(22) Filed: Jun. 6, 2025

Related U.S. Application Data
(60) Provisional application No. 63/656,850, filed on Jun. 6, 2024.

(51) Int. Cl. H04L 9/40

(52) U.S. Cl. CPC H04L 63/1425; H04L 63/02

(57) ABSTRACT

A cloud-based process management system and/or method can include a plurality of edge nodes that collect process data to create a real-time database and can communicate via a firewall to a cloud facility that synchronizes data from the real-time database for storage in a time-series database which can be used by machine learning modules. Such machine learning modules may serve to update quality assurance criteria used by microservices to control processes.

### CROSS-REFERENCE TO RELATED APPLICATIONS

This application claims the benefit of priority to U.S. Provisional Patent Application No. 63/656,850, filed on Jun. 6, 2024, titled “Cloud-Based Process Management”, the entire contents of which are incorporated herein by reference in their entirety.

### TECHNICAL FIELD

The embodiments generally relate to the field of process control, and more particularly to detecting and/or predicting abnormal process parameters in a manufacturing process.

### BACKGROUND

In the present manufacturing industry, the capacity to make informed and immediate decisions, as well as to maintain technological agility, is not only important but also essential to reduce losses caused by potential disruptions. Such processes can occur in a variety of production facilities; for example, electric arc furnaces, reheating furnaces, rolling mills, coating lines, packing lines, oil refineries, machining facilities, pickling facilities, tandem mills, or any other process within the field of product.

The product quality process is complex, and each product type has a specific set of parameters that must be followed to ensure that the product is manufactured according to its specifications. Therefore, it is challenging to solve quality problems in real-time. Any alteration in a variable, such as temperature, pressure, production speed, additions and/or alloys, changes in cooling water, or the product solidification process, can ultimately affect the mechanical result, chemical composition, shape, etc., of the final product.

### SUMMARY OF THE INVENTION

This summary is provided to introduce a variety of concepts in a simplified form that is further disclosed in the detailed description of the embodiments. This summary is not intended for determining the scope of the claimed subject matter.

In general, the disclosed software, system, and/or method may be provided for managing a process that generates process data related to process parameters, including process parameters that are adjusted by process controllers.

In some embodiments, a system can have a plurality of edge nodes with a data collection module that collects process data relevant to one or more process parameter. A raw data quality module can be used to verify the collected data relative to prescribed data veracity criteria, and if the collected process data are determined to meet the data veracity criteria, the module marks the verified data accordingly. A time-stamping module can apply a time stamp to this marked data, which can be stored in a real time database (RTDB).

In some embodiments, the edge node has one or more microservice modules that access time-stamped data from the RTDB. Such microservice modules may provide instructions to one or more of the process controllers responsive to such accessed data and may evaluate the accessed data to detect a present and/or anticipated abnormal change based on provided detection criteria. Responsive to such detection, the microservice module may performing a corresponding action, such as providing an abnormal change notification to one or more of the process controllers and/or flagging the associated time-stamped data stored in the RTDB.

Each edge node can have a node bridge module that communicates with the RTDB and with a cloud facility via a data network connection. At least one firewall is provided between the edge node and the cloud facility. The cloud facility can have a cloud bridge module that communicates with each of the node edges via the data network connection to receive time-stamped data from the RTDBs.

The cloud facility can have a time-series database (TSDB) and a data storing module that stores at least a subset of the data received from the edge nodes in the TSDB. One or more synchronization modules can correlate data stored in the TSDB based on time to provide a time-correlated set of data, which in turn can be provided to one or more machine learning modules. The machine learning modules can process one or more sets of correlated data from the TSDB to provide advanced process control functions, such as generating updated criteria for detecting a present and/or anticipated abnormal change and/or updating information stored in a historical database (which itself may store the correlated data provided by the synchronization routine(s)). The updated criteria may be provided to one or more of the microservices in the edge nodes for use evaluating the accessed data to detect a present and/or anticipated abnormal change with regard to one or more process parameters. The updated criteria may be used for other purposes, such as to generate reports or alerts.

In some embodiments, the system can provide information to a user via a user interface that communicates with the cloud facility. The cloud facility may have a virtual assistant that communicates with the user interface and with a user's/permissions database that stores verification data for users. The virtual assistant may compare user data provided via the user interface with the verification data stored in the users/permissions database to determine what degree of access to provide a particular user. The cloud facility may have one or more historical data microservices that retrieve an appropriate subset of correlated data from the historical database for presentation to the user via the user interface, subject to a determination by the virtual assistant that access to such correlated data is appropriate for that particular user.

In some embodiments, a method for managing a process can employ a plurality of edge nodes that communicate with a cloud facility via one or more firewalls. Each edge node may act to collect process data relevant to one or more process parameters, verify that such data meets prescribed data veracity criteria, and if so, mark the data as verified data. A time stamp can be applied to the verified data and such time-stamped data stored in a real time database (RTDB). An edge node can employ a microservice to access the time-stamped data from the RTDB and provide instructions to one or more of the process controllers in response to such accessed data. The microservice may act to detect a present and/or anticipated abnormal change and, if such is detected, performing an appropriate action in response, such as providing an abnormal change notification to one or more of the process controllers and/or flagging the associated time-stamped data stored in the RTDB.

The method can include the step of communicating data stored in the RTDBs of multiple edge nodes to the cloud facility, and the cloud facility can store at least a subset of the received time-stamped data in a time-series database (TSDB). The cloud facility may correlate a subset of data stored in the TSDB based on time and may provide such correlated data to one or more machine learning modules. The machine learning modules may process such correlated data to provide advanced process control functions, such as generating updated criteria for detecting a present and/or anticipated abnormal change and/or updating information stored in a historical database (which itself may store the correlated data provided by the synchronization routine(s)). The updated criteria may be provided to one or more of the microservices in the edge nodes for use evaluating the accessed data to detect a present and/or anticipated abnormal change with regard to one or more process parameters. The updated criteria may be used for other purposes, such as to generate reports.

The method may serve to provide information to a user via a user interface that communicates with the cloud facility. The cloud facility may compare user data provided via the user interface with verification data stored in a user's/permissions database to determine what access to provide the user. Responsive to determination that access is appropriate, the cloud facility may retrieve an appropriate subset of correlated data from the historical database and provide such retrieved data to the user via the user interface.

In some embodiments, each edge node may be further configured to operate autonomously in a disconnected state, using locally cached specifications and historical conditions to continue predictive evaluations. This autonomy supports system resilience during temporary network outages or intentional isolation, such as during maintenance or cybersecurity events. The ability of edge nodes to independently execute microservices based on previously synchronized cloud logic represents a fault-tolerant approach that improves system reliability. This architecture also permits edge-level experimentation or model testing before global deployment.

In addition to monitoring process parameters, the system may use device-specific health indicators as input features for predictive analysis. These may include vibration signatures, internal error codes, temperature drifts, or calibration offsets associated with sensors and controllers. Including such metadata allows the machine learning module to differentiate between systemic process anomalies and localized instrumentation faults. This improves root cause isolation, reduces unnecessary alerts, and enhances trust in system-generated recommendations.

The architecture of the edge node may also support execution of AI-accelerated models using local inference engines or specialized hardware (e.g., TPUs, GPUs, or FPGAs). This enables selective deployment of resource-intensive functions directly at the process site, reducing dependency on centralized cloud processing. Such capabilities are advantageous in applications where decisions must be made in milliseconds to protect product integrity or ensure operator safety. The flexibility to deploy lightweight or advanced models at the edge represents a scalable and adaptive control framework.

The cloud facility may be integrated into a hybrid or federated infrastructure that supports compliance with data localization regulations or enterprise-level security controls. For example, a manufacturing site in a regulated jurisdiction may route sensitive data through a local private cloud, while non-sensitive features are shared with a public machine learning platform. This hybrid deployment model enables compliance without compromising system intelligence. The modular cloud design further supports multi-tenant usage and segmented deployment across distinct facilities or business units.

To improve the explainability and auditability of predictions, the system may generate confidence scores or anomaly attribution metrics alongside alerts. These may indicate the statistical deviation of a process variable from normal operation, the relevance of each input feature, or a ranked list of potential root causes. This transparency allows operators to trust AI-driven guidance while still exercising discretion when responding to alerts. It also enables ongoing model refinement based on human-in-the-loop feedback.

In some embodiments, the system includes a visualization layer that graphically overlays real-time process behavior with learned boundaries and historical patterns. This allows users to see not only whether a value is out of specification but also how it has trended over time, how rapidly it changed, and how similar situations resolved in the past. These contextual cues improve decision-making and reduce alarm fatigue caused by poorly tuned static thresholds. This visual intelligence layer thus bridges the gap between raw data and actionable insight.

The system is also designed to support staged deployment and onboarding, enabling gradual integration into existing operations without the need for disruptive upgrades. For instance, edge nodes may initially operate in passive mode to collect baseline data before active control logic is deployed. Similarly, microservices and models can be activated sequentially based on observed performance, user readiness, or risk tolerance. This incremental adoption path makes the system suitable for greenfield and brownfield installations alike.

Data integrity and traceability are reinforced by the inclusion of structured metadata with each time-stamped data point. This metadata may include source device identifiers, calibration state, measurement confidence, and processing lineage. Such enriched records allow for forensic-level diagnostics and regulatory compliance, especially in industries with strict quality assurance standards. These attributes also support audit trail generation and retrospective validation of automated control decisions.

Another advantage of the disclosed system is the ability to incorporate domain-specific knowledge or heuristic rules alongside machine-learned criteria. For example, quality control guidelines derived from engineering handbooks or operator experience may be encoded as static rules and used in conjunction with data-driven models. This hybrid logic approach improves robustness and makes the system more interpretable and acceptable to human stakeholders. It also supports safety-critical deployments where fail-safe logic must be explicitly defined.

Overall, the invention provides a cohesive yet modular framework for real-time process intelligence, combining edge-level responsiveness with cloud-scale learning and oversight. By integrating traditional control systems with AI-enhanced decision-making, the system enhances manufacturing agility, product consistency, and operational efficiency. The combination of secure communication, adaptive analytics, and human-centric interfaces results in a platform capable of continuous improvement. These technical and architectural innovations contribute materially to the advancement of industrial automation.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 is a schematic view that illustrates a cloud-based system for process control, according to some embodiments disclosed herein. The system has a number of edge nodes that communicate with a cloud facility;

FIG. 2A is a schematic view that illustrates a single edge node shown in FIG. 1.

FIG. 2B is a schematic view that illustrates a cloud shown in FIG. 1.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system, software, or a method for process management; in any reference to one of these, it should be understood that analogous other forms of implementation should be included. For conciseness, the present description frequently refers to embodiments simply as “software”, which should be interpreted to encompass systems and methods. Where a system is described, a method comprising steps that correspond to the functions performed by elements of the system should be understood as included. The embodiments may provide cloud-native computing AI-powered software that analyzes real-time data to predict quality anomalies in production according to product specifications and machinery conditions. Such cloud-native computing software and methods can create an intelligent automated assistant system to connect the manufacturing process with an Artificial Intelligence (AI) bot. This software may serve to predict any production anomalies based on product specifications and machinery conditions. The software and method may be implemented using various platforms, including instant messaging apps, web interfaces, email, smartphones, wearables, and more, or any combination of these platforms.

The embodiments may serve to leveraging cutting-edge technology applications, including edge computing, machine learning, and cloud-based solutions. It may introduce AI bot assistants to effectively manage information and autonomously adapt to changes in product quality, such as variations in raw materials or environmental conditions. These assistants, powered by advanced algorithms, may be used to predict and recognize changes, presenting a comprehensive approach to enhancing product quality. The software may be designed to dynamically adjust its predictive models and algorithms based on the changing quality conditions, ensuring benefits in the process control such as continuous accuracy and reliability.

Embodiments may provide a comprehensive view of the production process, enabling swift, informed decision-making. This, in turn, may result in a reduction of losses since potential disruptions can be detected and resolved before they become serious.

The software may allow personnel involved in product quality to effortlessly access all variables involved in the production process and correlate the conditions of the production line machinery with the final product's outcomes. This may allow users to receive relevant information on the status of the process, and such information may include instant warning messages, behavior of any variable, trend graphs, and/or recommendations to solve production problems. The variables involved in the process typically change their values in real-time, providing information about the quality conditions under which production is being carried out.

The product quality process may depend on parameters such as temperature, pressure, production speed, additions and/or alloys, changes in cooling water, or the product
solidification process, can ultimately affect the mechanical result, chemical composition, shape, etc., of the final product.

The software may be designed to proactively maintain product quality. It may react to deviations and/or may actively collects data from various sources, assign each value to its corresponding production unit, and predict deviations in real-time. Employing a proactive approach may allow for immediate corrective actions to maintain a production process within desired parameters.

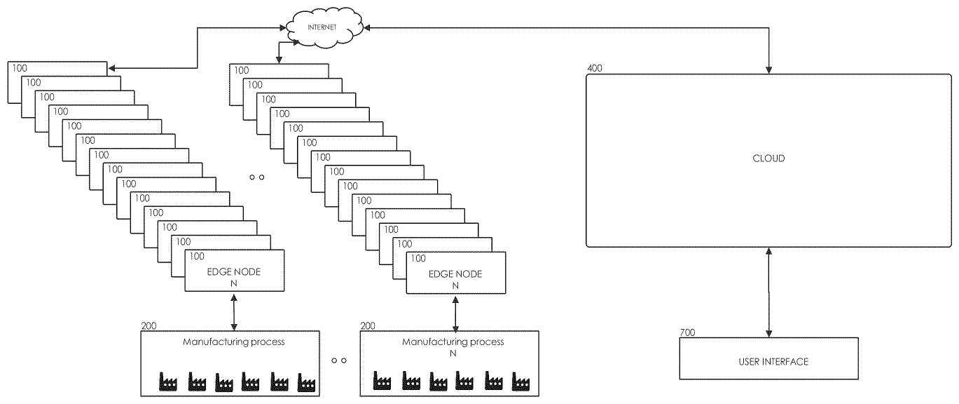

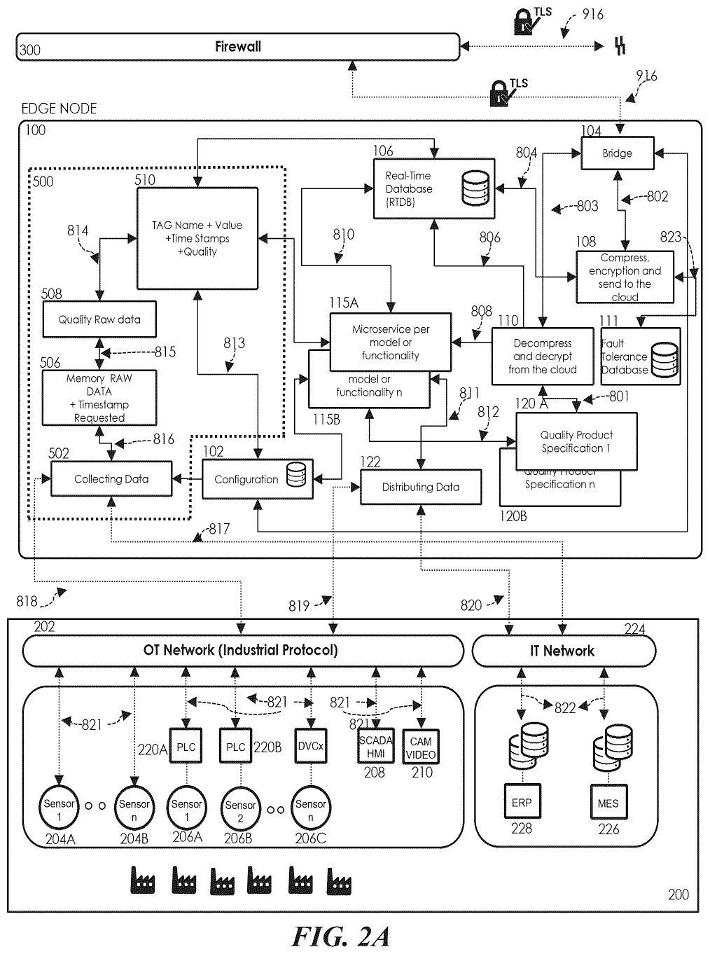

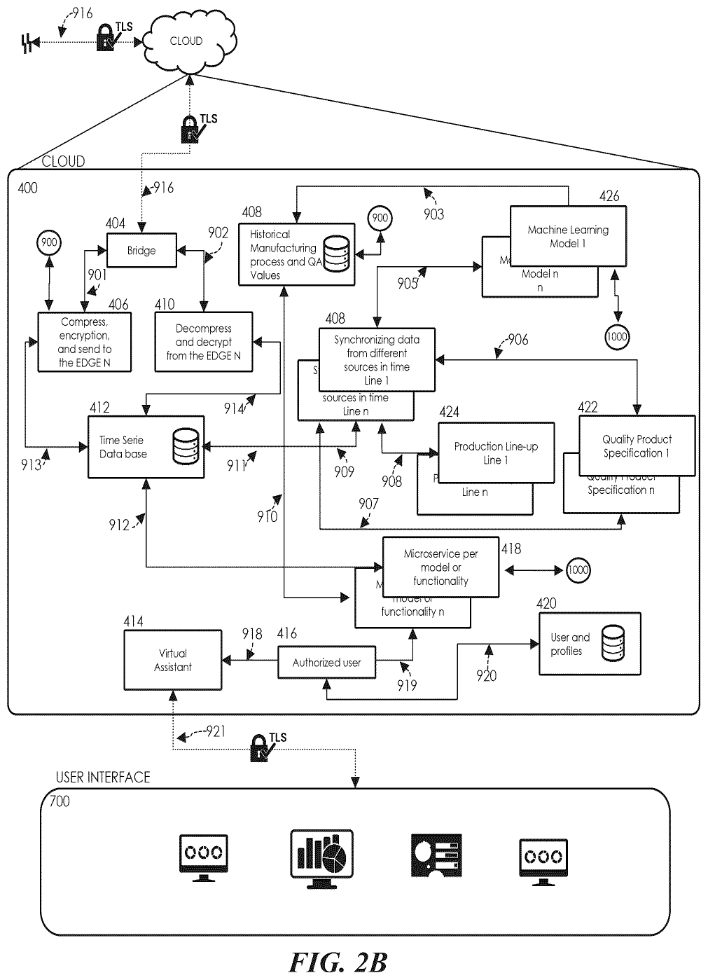

FIG. 1 is a schematic diagram of the general configuration of one embodiment of a system, which includes a plurality of edge nodes 100 and a cloud facility 400. The system is used to control/monitor examples of production process of processes 200 that can each communicate with a plurality of the edge nodes 100 that can collect, process, and make the information available in real-time to be used by all the processes involved. Communication between the edge node 100 and the cloud facility 400 may be provided through the internet connection and protected by a firewall 300. After the data is available and has been processed, it may already be available for the cloud facility 400 to send notifications of such availability to a user through the user interface 700. The details of FIG. 1 are shown further broken down in FIGS. 2A and 2B.

FIG. 1 provides an architectural overview of the distributed cloud-based process management system. As shown, a plurality of edge nodes 100 are geographically and logically distributed across various manufacturing environments, each associated with one or more manufacturing processes 200. These edge nodes are deployed proximal to the equipment or process line, enabling localized acquisition, verification, and preprocessing of operational data prior to transmission to the cloud facility 400. Each edge node 100 may be configured based on the specific process variables it is intended to monitor, such as thermal behavior, material flow, or equipment performance.

The architecture promotes horizontal scalability by supporting an arbitrary number N of edge nodes, each capable of independent operation but designed to interoperate through a secure and synchronized framework. The edge nodes 100 are connected to a central cloud facility 400 via the Internet, allowing real-time data streaming. This data pipeline is secured by at least one firewall 300 (as further detailed in FIG. 2A), which safeguards data integrity and ensures only authorized and encrypted communications traverse the system boundary.

Each edge node 100 is capable of executing specific microservices that preprocess data locally and provide immediate response capabilities without needing round-trip communication with the cloud. This edge intelligence reduces latency for critical control operations. Once data is validated and time-stamped, it is pushed via the Internet to the cloud facility 400 using a transport layer encryption protocol (e.g., TLS). In the cloud, the data is further aggregated, correlated, and analyzed across multiple edge sources to provide global insights into manufacturing efficiency, quality, and predictability.

The cloud facility 400 acts as the central orchestrator of long-term analytics, synchronization, and machine learning functions. Data received from edge nodes is routed to time-series and historical databases and made accessible to authorized users via the user interface 700. This interface may include web-based dashboards, mobile applications, or messaging platforms. Notifications and alerts may also be pushed to the user interface 700 to inform stakeholders of process deviations, system statuses, or recommended corrective actions based on AI-driven insights.

Overall, FIG. 1 demonstrates how the system employs a tiered structure for data collection, verification, processing, and utilization. It highlights the interaction between edge-level autonomy and cloud-level intelligence, both of which are essential for modern smart manufacturing environments. By enabling bidirectional communication between edge nodes and the cloud, the system ensures not only robust data acquisition but also efficient dissemination of updated parameters, models, or control logic back to the production lines in near real-time.

As shown in FIG. 2A, the product quality 200 process needs control systems that are fed by measuring instruments that allow seeing and understanding what is happening in the process. Examples of such control systems can comprise programmable logic controllers (PLCs) 220, Supervisory Control and Data Acquisition (SCADA) 208, and Human-Machine Interface (HMIs 208), and are not limited just to these. In the same way, the product quality 200 process can use specifications and manufacturing criteria that may be stored in databases that are supported by enterprise resource planning (ERP) 228, manufacturing execution system (MES) 226, and/or

databases themselves, whose information is used to configure the process according to the characteristics of the product that is needed.

The edge node 100 can employ a set of Microservices container technologies, each tailored to specific functionalities within the product manufacturing process, such as arc furnaces, electric furnaces, reheating furnaces, laminators, coating lines, packaging lines, oil refineries, gas compression plants, distilleries, machining, pickling, tandem mills, and other manufacturing processes. This technology can facilitate the creation of essential tasks and functionalities. Microservices represent an architectural and organizational approach to software development, comprising small independent services that communicate through well-defined APIs. These services are overseen by small independent teams.

The edge node 100 may has a collecting data 502 module that ingests data from the sources that are required according to the variable that monitored by that particular edge node. This collecting data 502 module may get the information through the OT Network 202; each source device 220, 204, 206 can have a different communication protocol, and depending on the manufacturer of the device, these devices may be connected 821 to the OT Network 202 to provide the information that the edge node 100 needs to get from them. The collecting data 502 module may get the configuration from the configuration 102 module. This configuration 102 module can provide the necessary information to know which and where the information needs to be obtained from devices 220, 204, and 206 in the product quality process 200. The data collected from devices 220, 204, and 206, by the collecting data 502 module can be placed 816 in the memory raw data 506 module with a timestamp requested. After the information is placed, the quality raw data 508 module can get 815 the data from the memory raw data 506 module. This module 508 can be responsible for verifying the quality of the data and its veracity as well; Module 508 can specify the criteria for evaluating data quality; for example, the data could be categorized as Bad, Uncertain, or Good. A “Bad” rating could indicate that the data is not useful, while “Uncertain” could suggest that the data deviates from the norm but may still be useful. On the other hand, “Good” could denote data that is valid and useful. As examples of criteria to classify data as “Bad,” the following criteria could be used: Communication error: Determines if there has been no prior communication with the value. Device Failure: Evaluates whether the value source is affected by a device or sensor failure. Configuration error: Identifies if the value is unusable due to inconsistencies in parameterization or configuration. Simulated value: Applies when the value is generated through a simulation process. Sensor failure: Applicable when the sensor reports a failure regarding itself. Out of range: Determines if the value is outside the defined minimum and maximum ranges. Similarly, examples of criteria to classify data as “Uncertain” could be as follows: Calibration: Applied when the data is not within the normal range. Conversion: Used when data conversion is inaccurate. Data could be considered “good” when none of the above conditions are met.

A mark can be placed if the data is already ready to use without error or abnormal conditions. The ready-to-use 510 module may be responsible for saving the data in the RTDB (Real-time Data Base) 106. The RTDB can provide a way to share the information within the modules that want to use the data for a specific microservice or functionality 115 inside the edge node 100. After the data is available in the RTDB, any processes using that stored data can receive a notification that the data is available and updated.

A particular microservice or functionality 115 may obtain the configuration of the assigned variable in the configuration module, after knowing which variable is assigned. The microservice may look for the monitoring and control information in the quality product specification 120, which includes the maximum, minimum, and aim value that it must control the process to meet customer requirements. In the same way, this configuration may include the information that the microservice or functionality can use to identify whom and/or what other element it should inform in case the variable undergoes any change that affects the process it is monitoring.

When the microservice or functionality 115 detects or predicts any abnormal change in the assigned variable, it can start the notification process, which can include informing the distributing data 122, which sends the information through the IT network 224. When the third-party processes 228, 226 receive the notification 822, the data in the RTDB 116 may be marked as out of specification according to the quality product specification 120.

The node bridge 104 module can send and receive data, configuration, and other information and updates required by the edge node 100. Node bridge 104 can use Message Queuing Telemetry Transport (MQTT) or equivalent messaging protocol for use on top of the TCP/IP protocol. The communication between node bridge 104 and cloud facility 400 may be through the Internet connection and may be encrypted by appropriate technique, such as by using TLS (Transport Layer Security) 916. The TLS protocol aims primarily to provide cryptography, including privacy, integrity, and authenticity through the use of certificates, between two or more communicating computer applications. It runs in the application layer and is composed of two layers: the TLS record and the TLS handshake protocols. Other protocols providing similar function could be employed.

Between the edge node 100 and the cloud bridge 404 of the cloud facility 400 is at least one firewall 300. A firewall 300 is a network security system that monitors and controls the incoming and outgoing network traffic based on predetermined security rules. A firewall typically establishes a barrier between a trusted network and an untrusted network, such as the Internet. While illustrated as an independent element, such a firewall could be incorporated into one or both of the node bridge 104 and the cloud bridge 404.

All data sent and received through node bridge 104 may be subject to encryption and compression using either the uncompress and decrypt 110 or the compress and encrypt 108 modules, as applicable. In the event that process 110, responsible for encrypting and transmitting the data through node bridge 104, receives an error message indicating a loss of communication between node bridge 104 and the cloud, the process could begin 823 storing the data in the fault tolerance database 111 and await the re-establishment of communication with the cloud before resending the data. This approach can ensure that no data is lost, and that useful information is available for future analysis and prediction modeling, avoiding loss of information that may cause uncertainty in prediction models.

The data can be transmitted by cable or wireless 916, which before being exposed and sent to the cloud or vice versa, passes through a firewall 300, which manages and grants access to valid source connections to avoid unauthorized intrusions.

Referring to FIG. 2B, after the data is collected at the cloud facility 400 through the cloud bridge 404, it is sent to task 410 for processing. Task 410 decrypts and decompresses the data. The data received may contain the following information: process data (i.e., time-stamped data from RTDB 106) or information request messages (i.e., requests for information to be used by one or more of the microservices 115). In the case of process data, the data is sent 914 to a time series database 412 for storage and use as described below. In the case of a request for information, the requested information may be available in the time series database 412 and/or in a historical manufacturing process and QA values database 408. The desired information is obtained by sending 901 a request to process 406 to be searched by means of a request 913 to the time series database 412 and/or through a request 900 to the Historical Manufacturing process and QA Values database 408 (while shown as sending 901 this request via cloud bridge 404, task 910 could send 901 the request to process 406 directly). The obtained information can then be then compressed and encrypted 406 before being sent to the edge node 100 that requested it via cloud bridge 404.

The various sources 818 817 and processing requirements of information that come from different sources in the product process may lead to different times when data from a specific moment is communicated to the cloud 400 through bridge 404. It is important to synchronize the timing of each occurrence in order to maintain consistent correlation time during the product manufacturing process. This may involve coordinating with the production line-up 424 and the quality product specification 422 for each product in the line-up 424. To achieve this, a synchronization routine 408 can be used. This routine 408 can also notify the machine learning model 426 when the data is ready and correlated for use. This system and method can allow data to be accessed and updated by multiple users or systems simultaneously, providing accurate and timely information.

The Cloud 400, there may be a dedicated machine learning model 426 for each of several of the multiple processes intended for quality control. These models can be designed to update the historical manufacturing process and quality assurance (QA) values in the historical database (409). This means that each specific process can be continuously improved based on the historical data stored in the database, leading to more efficient and effective quality control measures.

In some embodiments, historical data 409 can be used to provide information when the user employs user interface 700 to request information for the specific product made in the product quality process. Requested information can be associated with specific cloud microservices 418 that prepare the information the user requested. Cloud microservices could also send an alert 1000 of quality deviation that the microservice received as soon as such alert 1000 is received from the machine learning model.

Users can request information through a virtual assistant 414. During the request process, the virtual assistant 414 verifies if the user has permission 416 to access the information by comparing the user's identification to a database of users and profiles 420. Once the user is verified and permission is obtained, the virtual assistant 414 can request the appropriate information from cloud microservice 418 and then send the requested information 921 to the user interface 700.

The user interface 700 could be shown in a web browser or messaging app that is configured to allow analyzing and/or verifying the variables involved in the product quality process that have an impact on the quality of the product.

As used in this specification and the accompanying figures, each reference numeral is intended to refer to a corresponding structural component or logical element of the disclosed system, regardless of whether such component is explicitly referred to as a “module,” “unit,” “element,” or “means.” For example, terms such as “data collection module” (502), “quality raw data module” (508), and “microservice module” (115A, 115B) are used to describe functional elements that may be implemented using a combination of hardware and/or software components, including processors, memory, programmable logic controllers, and executable code, without limiting these terms to a specific form of embodiment. These references are used for clarity and consistency in describing the invention and are not intended to invoke the means-plus-function provisions unless explicitly stated as such using the phrase “means for.” All such modules, components, or systems should be interpreted as having corresponding structure described in this specification, including algorithms, logic flow, or hardware configurations, sufficient to perform the claimed functions.

The system illustrated in FIG. 1 is not merely a generalized computing environment but a highly specialized cloud-based process management architecture. It includes a plurality of edge nodes 100 that are physically and logically integrated into industrial manufacturing processes 200. These edge nodes are not generic computing devices; they are equipped with real-time data acquisition capabilities and microservice modules specifically designed to interface with industrial OT networks. This configuration represents a technical improvement over prior art systems that rely on periodic batch uploads or passive monitoring by enabling real-time predictive control through synchronized cloud analytics.

Each edge node 100 as shown in FIG. 2A is configured with a collecting data module 502, a memory raw data module 506, a raw data quality module 508, and a ready-to-use module 510 that collectively implement a robust real-time data verification process. This process is not a mere abstraction but a concrete technical workflow that filters, timestamps, and validates sensor data based on predefined veracity criteria. The use of a time-stamping module and quality classification (e.g., “Good,” “Uncertain,” “Bad”) ensures that only actionable, high-integrity data is passed to the real-time database (RTDB) 106. This improves the functioning of the industrial system by reducing false positives, increasing reliability, and allowing downstream modules to react to trusted data in near real time.

Unlike conventional systems that rely on central servers for all analytics, the disclosed system employs decentralized microservices 115 in the edge node 100. These microservices are configured to access time-stamped data directly from the RTDB 106 and are equipped to detect and respond to abnormalities based on quality product specifications 120. In doing so, they execute advanced control logic locally, minimizing the need for cloud-based latency-prone decision-making. This localized processing capability is enabled through a novel edge-cloud partitioning strategy, which contributes to a substantial improvement in system response time and operational reliability.

Referring to FIG. 2A, the edge node 100 also includes a node bridge module 104 that manages secure data exchange with the cloud facility 400 shown in FIG. 2B. The node bridge is not a generic network adapter, but a dedicated component configured with compression and encryption modules 108 and 110, respectively, that implement TLS 916 protocols for industrial-grade security. Moreover, the edge node includes a fault tolerance database 111 that stores validated data in the event of network interruptions, ensuring uninterrupted operations. These structural features constitute more than an abstract idea-they are concrete components solving the technical challenge of secure and reliable cloud communication in real-time environments.

The cloud facility 400, as illustrated in FIG. 2B, receives time-stamped data via the cloud bridge 404 and directs it to processing task 410, which separates incoming content into process data and information requests. This task execution is not generic data routing; it includes decrypting, decompressing, and conditionally parsing data based on its purpose. The system then routes process data to a time-series database (TSDB) 412 and maintains synchronization of incoming data streams using synchronization routines 408. These elements provide a non-abstract solution to the well-known problem of time-alignment across multiple asynchronous data sources.

FIG. 2B further illustrates a machine learning module 426 that processes the time-correlated data to generate updated detection criteria used by the microservices 115 at the edge. This module is not performing mathematical operations in the abstract but is tied directly to industrial applications, using real-world process data to improve anomaly detection. The generated models and criteria are physically and functionally returned to edge devices where they are applied in real-time operations. This closed-loop integration between cloud learning and edge deployment exemplifies a technical improvement to industrial system adaptability, precision, and control.

A key technical benefit is realized through the interaction between the historical database 409 and the virtual assistant 414, which provides user-requested data via the user interface 700. The virtual assistant is not simply executing a search function; it is cross-referencing access credentials stored in the user/permissions database 420 and filtering the response based on role-based access control. These features collectively support secure, context-aware data delivery within an enterprise environment. By dynamically curating query results based on user profile and permissions, the system improves over conventional user interfaces that offer static data retrieval.

The user interface 700 itself is not a generic GUI but a specialized interface configured to support real-time visualization, user-driven queries, and actionable alerts. FIG. 1 illustrates how the cloud facility 400 communicates with the user interface to deliver synchronized data summaries, quality control alerts, and historical trend graphs. Users may receive intelligent prompts and recommendations generated from the ML module 426, enhancing their ability to make timely and informed decisions. These enhancements address the technical challenge of cognitive overload in complex industrial environments by surfacing the most relevant information at the right time.

The system architecture, including edge nodes, RTDBs, TSDBs, cloud bridges, and machine learning components, works together to achieve outcomes that are not possible with conventional computing configurations. The modularity, security, synchronization, and adaptability of the system are tailored to industrial applications requiring both scale and precision. The invention does not claim the mere idea of data processing or anomaly detection—it claims a specific, structured, and integrated system that improves the reliability and efficiency of industrial process management. Each component is interdependent and contributes materially to the improved technical functioning of the overall system.

Accordingly, the system as claimed and described is not directed to an abstract idea or mental process. It is directed to a structured, technical, and practical solution to specific problems encountered in cloud-based industrial automation. These include data integrity validation, real-time latency minimization, secure communication, and adaptive control via machine learning. The claims are thereby rooted in computer and control technology and result in a tangible improvement to the functioning of computing systems and industrial operations alike.

As used herein, the term “module” refers broadly to a distinct set of computer-executable instructions, a hardware component, or a combination thereof that is configured to perform a specific function within the system. A module may operate independently or in conjunction with other modules to carry out more complex operations. Such modules may reside within a single computing device or be distributed across multiple devices that communicate over a network.

The term “edge node” refers to a physically localized computing unit strategically positioned near or at the source of process data generation within an industrial or manufacturing setting. An edge node may include one or more processors, memory devices, networking interfaces, and input/output ports. It is configured to receive, process, validate, and transmit data originating from sensors, control systems, or industrial machinery. The purpose of the edge node is to offload computation from central servers, reduce latency, and enable real-time decision-making at the site of data origin.

As used herein, a “real-time database” (RTDB) is a data management structure that allows for the continuous ingestion, immediate storage, and near-instantaneous availability of data to dependent services or modules. The RTDB operates in memory or with low-latency storage media to ensure that recent data is accessible for time-sensitive operations. This architecture supports high-throughput, low-delay data access, enabling modules such as microservices or controllers to take prompt actions. RTDBs are particularly suited for environments that require dynamic control and rapid feedback cycles.

The term “cloud facility” encompasses one or more networked data centers, computational environments, or virtualized services configured to aggregate, process, store, and analyze information originating from distributed edge nodes. The cloud facility may utilize centralized or decentralized architecture, depending on operational and performance requirements. It may include compute nodes, storage arrays, application servers, and orchestration tools for managing incoming and outgoing data flows. The cloud facility enhances system scalability, supports advanced analytics such as machine learning, and allows for multi-user access to synchronized process insights.

A “time-series database” (TSDB) is defined herein as a purpose-built data repository optimized for the storage and querying of time-stamped data sets. The TSDB allows for efficient organization of sequential process values over time, enabling both retrospective analysis and trend forecasting. It supports indexing, compression, and correlation mechanisms specifically tailored for temporal datasets common in industrial environments. This database plays a critical role in synchronizing data from multiple edge sources for use in training and executing machine learning models.

The term “microservice” refers to a lightweight, autonomous software process that executes a narrowly scoped function, typically exposed through an API or messaging queue. Microservices are independently deployable and are often managed via containerization or serverless frameworks. Within the disclosed system, microservices may carry out specific tasks such as anomaly detection, threshold monitoring, or alert generation. This modular approach allows for improved maintainability, fault isolation, and rapid scalability across both edge and cloud layers of the architecture.

As used herein, a “machine learning module” refers to a set of algorithms, data processing logic, and possibly dedicated hardware designed to extract patterns or inferences from correlated data. This module may utilize various models, including supervised, unsupervised, and reinforcement learning techniques, depending on the process optimization goals. Machine learning modules may be trained on historical data, refined with feedback from live data, and periodically updated to enhance prediction accuracy. Their outputs may include updated detection criteria, recommendations, or automated control actions.

The term “virtual assistant” refers to a conversational interface that allows users to access system data or insights through natural language queries, whether textual or spoken. The virtual assistant may be embedded within a user interface and is configured to interpret the user's intent using natural language processing (NLP) techniques. Upon authentication and validation, the assistant retrieves and presents contextually relevant data from one or more sources within the cloud facility. This feature simplifies user access to complex datasets and improves overall system usability.

The term “data” as used throughout this disclosure encompasses any representation of physical, digital, or logical signals that convey information. This includes raw sensor readings, computed metrics, timestamps, metadata, or derived variables used in predictive models. Data may be structured or unstructured, real-time or historical, and may be generated or consumed by various system components. In this application, the management of data integrity, timing, and verifiability is central to the system's predictive control functionality.

Each function described in connection with a component, module, or process may be implemented using dedicated hardware, programmable logic, or software executing on general-purpose processors. Although specific roles are described as being assigned to particular modules or systems, it should be understood that the distribution of functionality may be adjusted without deviating from the scope of the invention. For example, a cloud function may be localized at the edge, or a microservice may interact with multiple databases. This functional flexibility ensures the adaptability of the system across a wide range of industrial deployments.

The system architecture, communication mechanisms, algorithms, and control logic are disclosed in a manner that permits one of ordinary skill in the art to implement and practice the invention without undue experimentation. The described system is more than an abstract idea; it is a concrete and practical application of computing technology to the domain of manufacturing process management. This includes novel technical improvements in data quality assurance, latency reduction, and intelligent process optimization.

The embodiments as claimed are not directed to a mere idea, rule, or result, but to a specific and tangible improvement in the way computer and control systems function. This includes architectural enhancements enabling near-real-time control, the use of machine learning models for predictive process adjustment, and secure, verifiable data synchronization. These improvements solve specific, recognized problems in the field of industrial automation and digital manufacturing. As such, the claimed invention should be understood as providing a technological solution rather than an abstract or mathematical concept.

The claims are not directed to generic computer implementation, but rather to a specialized configuration of edge devices, cloud infrastructure, and coordinated software agents working in concert. The invention improves computer functionality itself, enabling new capabilities such as localized model inference, process-aware data filtering, and traceable data validation workflows. These capabilities were not previously available through conventional means and represent significant advances in industrial control systems. The claims should therefore be interpreted in view of these specific technological contributions.

The use of terms such as “configured to,” “adapted to,” or “capable of” is intended to describe operational capabilities that are supported by structural and software elements disclosed in this specification. These phrases do not imply functional abstraction, but rather identify what the system elements are specifically designed to achieve. For example, a module configured to transmit data includes all necessary logic and hardware to perform that transmission.

The phrase “at least one” means one or more of the named items and should not be interpreted as limiting the claim to only one. Similarly, the phrase “a plurality of” is intended to indicate two or more elements. These terms are used consistently throughout the specification to define quantities or groupings and are understood to include combinations and subcombinations of the named elements. This usage is standard in patent practice and supports broad but definite claim interpretation.

Whenever examples are provided using terms like “e.g.,” “such as,” or “for example,” they are intended to be illustrative and non-limiting. These examples help to clarify the concepts and functionality described, but they do not define or restrict the claimed invention to those particular instances. For example, a listed protocol, architecture, or sensor type may represent one possible embodiment among many. All examples should be interpreted as supportive of the full claim scope as described and claimed.

Descriptions of software modules throughout this application are not limited to software-only implementations. Each software-based function may also be implemented using digital logic circuits, field-programmable gate arrays (FPGAs), application-specific integrated circuits (ASICs), or other hardware configurations. In some embodiments, hybrid approaches may be employed wherein certain tasks are accelerated using co-processors or hardware-based inference engines. Thus, references to “software” should be interpreted broadly to include all suitable forms of implementation.

Where features are described as “preferred,” “optional,” or “illustrative,” they are intended to support alternative claim sets and should not be interpreted as limiting the scope of any particular claim unless explicitly stated. Many features described in the specification may be claimed independently or in various subcombinations, as supported by the written description. This supports the flexibility to pursue multiple claim strategies during prosecution and aligns with principles of compact prosecution and clarity under MPEP §§ 2173 and 2111. Each such variation is expressly contemplated as part of this disclosure.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for managing a process that generates process data related to process parameters including process parameters that are adjusted by process controllers, the system comprising:
a plurality of edge nodes, each of the plurality of edge nodes having:
a data collection module to collect at least a subset of process data relevant to at least one process parameter;
a raw data quality module that verifies the collected data relative to prescribed data veracity criteria and marks the verified data if determined to meet the data veracity criteria;
a time-stamping module that applies a time stamp to the marked data determined to meet the data veracity criteria,
a real-time database (RTDB) for storing the time-stamped data,
at least one microservice module that accesses time-stamped data from the RTDB and provides instructions o at least one of the process controllers responsive to such accessed data,
the microservice module evaluating the accessed data to detect a present and/or anticipated abnormal change and, responsive to such detection, performing at least one function from the group of:
providing an abnormal change notification to at least one of the process controllers, and
flagging the associated time-stamped data stored in the RTDB,
a node bridge module that communicates with the RTDB and with a data network connection;
a cloud facility having,
a cloud bridge module that communicates with each of said node edges via the data network connection to receive time-stamped data from said RTDBs,
a time-series database (TSDB),
a data storing module that stores at least a subset of the received data in said TSDB,
at least one synchronization module that correlates a subset of data stored in said TSDB based on time,
at least one machine learning module that receives and processes at least one set of correlated data from said TSDB to generate updated criteria for detecting a present and/or anticipated abnormal change; and
at least one firewall connected between the node bridge module and the cloud bridge module.

2. The system of claim 1, wherein the updated criteria generated by at least one of said machine learning modules is provided to at least one of said microservices for use evaluating the accessed data to detect a present and/or anticipated abnormal change.

3. The system of claim 1, wherein the cloud facility includes a historical database that stores the correlated data provided by at least one processing selected from the group of:
the machine learning module, and
the synchronization routes.

4. The system of claim 3, wherein at least one of said machine learning modules acts to update the correlated data stored in said historical database with regard to at least one process parameter.

5. The system of claim 3 wherein the system can provide information to a user via a user interface, and wherein said cloud facility further comprises:
a virtual assistant that communicates with the user interface;
a user's/permissions database that stores verification data for users,
said virtual assistant comparing user data provided via the user interface with the verification data stored in said users/permissions database to determine what access to provide the user; and
at least one historical data microservice that, responsive to determination by said virtual assistant that access is appropriate, retrieves an appropriate subset of correlated data from said historical database for presentation to the user via the user interface.

6. A method for managing a process responsive to process data related to process parameters including process parameters that are adjusted by process controllers, the method comprising the steps of:
employing a plurality of edge nodes to each perform the steps of,
collecting at least a subset of process data relevant to at least one process parameter,
verifying the collected data relative to prescribed data veracity criteria and marking the data as verified data if determined to meet the data veracity criteria,
applying a time stamp to the verified data and storing such time-stamped data in a real time database (RTDB),
employing a microservice to access the time-stamped data from the RTDB and provide instructions to at least one of the process controllers responsive to such accessed data to detect a present and/or anticipated abnormal change and, responsive to such detection,
performing at least one function from the group of:
providing an abnormal change notification to at least one of the process controllers, and
flagging the associated time-stamped data stored in the RTDB;
communicating at least a subset of the data stored in the RTDB to a cloud facility via at least one firewall;
employing the cloud facility to perform the steps of,
receiving time-stamped data from the RTDBs of the edge nodes,
storing at least a subset of the received time-stamped data in a time-series database (TSDB),
correlating a subset of data stored in the TSDB based on time,
employing at least one machine learning module to process at least one set of correlated data to generate updated criteria for detecting a present and/or anticipated abnormal change.

7. The method of claim 6, wherein said cloud facility further provides the step of communicating the updated criteria generated by the at least one machine learning module to at least one of the microservices for use detecting a present and/or anticipated abnormal change.

8. The method of claim 6, wherein said cloud facility performs the further step of storing at least a subset of the data correlated based on time in a historical database.

9. The method of claim 8, wherein said cloud facility performs the further step of employing at least one of machine learning modules to update the correlated data stored in the historical database with regard to at least one process parameter.

10. The method of claim 8, wherein the method can provide information to a user via a user interface and said cloud facility performs the further steps of:
communicating with the user interface to receive user data;
comparing user data provided via the user interface with verification data stored in a user's/permissions database to determine what access to provide the user; and
responsive to determination that access is appropriate, retrieving an appropriate subset of correlated data from the historical database and providing such retrieved data to the user via the user interface.

11. A system for managing a process that responds to microservices and generates process data related to process parameters to provide information to a user via a user interface,
the system comprising:
a plurality of edge nodes, each of the edge nodes having,
a data collection module to collect at least a subset of process data relevant to at least one process parameter,
a raw data quality module that verifies the collected data relative to prescribed data veracity criteria and marks the verified data if determined to meet the data veracity criteria,
a time-stamping module that applies a time stamp to the marked data determined to meet the data veracity criteria,
a real time database (RTDB) for storing the time-stamped data,
a node bridge module that communicates with the RTDB and with a data network connection;
a cloud facility having,
a cloud bridge module that communicates with each of said node edges via the data network connection to receive time-stamped data from said RTDBs,
a time-series database (TSDB),
a data storing module that stores at least a subset of the received data in said TSDB,
at least one synchronization module that correlates a subset of data stored in said TSDB based on time,
at least one machine learning module that receives and processes at least one set of correlated data from said TSDB to generate updated criteria for detecting a present and/or anticipated abnormal change;
a historical database that stores the correlated data provided by said at least one synchronization routine,
wherein at least one of said machine learning modules acts to update the correlated data stored in said historical database with regard to at least one process parameter,
a virtual assistant that communicates with the user interface,
a user's/permissions database that stores verification data for users,
said virtual assistant comparing user data provided via the user interface with the verification data stored in said users/permissions database to determine what access to provide the user, and
at least one historical data microservice that, responsive to determination by said virtual assistant that access is appropriate, retrieves an appropriate subset of correlated data from said historical database for presentation to the user via the user interface; and
at least one firewall connected between said node bridge module and said cloud bridge module.

12. The system of claim 11, wherein the data collection module is configured to retrieve data from a plurality of sensor types selected from the group consisting of temperature sensors, pressure sensors, flow meters, level sensors, and optical inspection systems.

13. The system of claim 11, wherein the raw data quality module applies a multi-level validation algorithm to classify the collected data as one of “Good,” “Bad,” or “Uncertain” based on predefined criteria including communication status, sensor diagnostics, range thresholds, and calibration status.

14. The system of claim 11, wherein each edge node comprises a memory buffer for storing unverified data when network connectivity is unavailable, and wherein the data is transmitted to the RTDB only after successful verification and time stamping.

15. The system of claim 11, wherein the time-stamped data in the RTDB is tagged with a unique identifier corresponding to a production batch, allowing batch-specific analysis across the cloud infrastructure.

16. The system of claim 11, wherein the synchronization module further comprises a scheduling engine configured to align data from multiple edge nodes based on timestamps and production line identifiers to generate unified process timelines.

17. The system of claim 11, wherein each machine learning module is configured to execute anomaly detection routines using time-series forecasting and classification models selected from the group consisting of recurrent neural networks, decision trees, and
support vector machines.

18. The system of claim 11, wherein the virtual assistant further comprises a natural language processing engine configured to interpret textual or voice-based user queries related to process data, machine status, or quality deviations.

19. The system of claim 11, wherein the user interface provides real-time visualization of production metrics through graphical dashboards, alert notifications, trend graphs, and recommendations generated by the machine learning module.

20. The system of claim 11, wherein the historical data microservice is further configured to generate a quality audit report for a specified time range, production line, or product identifier, comprising data retrieved from the historical database and associated quality product specifications.
